(19) United States
(12) Patent Application Publication
(10) Pub. No.: US 2008/0158500 A1
(43) Pub. Date: Jul. 3, 2008

(54) Display Device and Method for Manufacturing the Same

(76) Inventors: Yasushi KAWATA, Ageo-shi (JP); Hideki Ito, Saitama-shi (JP); Akio Murayama, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/955,878

(22) Filed: Dec. 13, 2007

(30) Foreign Application Priority Data
Dec. 27, 2006 (JP) 2006-351383
Dec. 27, 2006 (JP) 2006-351384

(51) Int. Cl. G02F 1/13; G09G 3/36

(52) U.S. Cl. 349/187; 345/87

(57) ABSTRACT

The present invention provides parallax barrier layers on a first transparent substrate. A second transparent substrate is adhesively attached to the parallax barrier layer side of the first transparent substrate. The opposite side to the parallax barrier layers of the first transparent substrate is polished. Various kinds of functional films are formed on the polished first transparent substrate to form a counter substrate. The positional displacement between each parallax barrier layer and each pixel can be suppressed, and uniformity of the visual field angle and yield can be enhanced.

### INCORPORATION BY REFERENCE

The present application claims priority under 35 U.S.C. §119 to Japanese Patent Application Nos. 2006-351383 and 2006-351384, both of which were filed on Dec. 27, 2007. The content of the application is incorporated herein by reference in their entirety.

### FIELD OF THE INVENTION

The present invention relates to a display device in which different images can be displayed in different directions when an object is observed in different directions, and a method for manufacturing the display device.

### BACKGROUND OF THE INVENTION

A conventional display device, that is, a display as a display device has been designed so that a plurality of users can view the display at the same time for many years of use, and the display characteristics thereof are set so that a plurality of observers can see the same high quality image on the display at even different viewing angles. This is effective in a case where a plurality of users requires the same information, such as departure information or the like in an airport or station from a display on which departure information or the like is displayed in an airport or station.

However, there are a plurality of applications in which it is required that individual users can view different information from the same display. For example, in the case of a vehicle, there is a case where a driver wants to look at satellite navigation data while a passenger wants to watch a movie. These conflicting demands can be satisfied by supplying two different displays, however, this occupies an unnecessary amount of space and increases the cost. Furthermore, when two different displays are used in this example, the driver can look at the display of the passenger by moving his/her head, however, this disrupts the driver's concentration.

As a further example, each of players who play a computer game suitable for two or more players may want to watch the game from his/her individual perspective. At present, this is implemented under a state in which the respective players view the game on their individual display screens. Accordingly, each player has his/her own unique perspective on each different screen. However, when a different display screen is supplied to each player, much space is occupied, and the cost is increased, so that this is not practical for portable games.

In order to solve these problems, a multiple view directional display has been developed. For example, a dual view display is known as an application example of the multiple view directional display. This display can simultaneously display two or more different images, and each image can be viewed in a specific direction, that is, an observer who views the display device from one direction views one image while an observer who views the display device from a different direction views a different image. The display which can supply different images to two or more users can save space and cost as compared with the case where two or more different displays are used.

Furthermore, as another application of the multiple view directional display, there is known a display which is used in aircraft and supplies an individual in-flight entertainment program to each passenger. At present, each passenger is typically provided with an individual display on the backside of the seat in the row directly in front. However, by using the multiple view directional display, service can be supplied to two or more passengers by one display, and each passenger can select a unique movie in accordance with his/her taste, so that cost, space and weight can be saved.

Still furthermore, an advantage of the multiple view directional display is the capability of making it impossible for users to view screen displays of others. This is desired in banks using automated-teller machines (ATM), applications requiring security such as sales transactions, etc., and computer games in the example as described above.

In a process of manufacturing a multiple view directional display as disclosed in Japanese Laid-Open Patent Publication No. 2005-78094, it is common that a color filter side substrate of a panel filled and sealed with liquid crystal is suitably polished to have a thickness of 20 to 100 μm, and then a substrate having parallax barrier layers formed thereon is attached to the liquid panel so that the parallax barrier layers are matched with the respective opposing pixels.

However, in the above case, a problem that the visual field angle is different among individual panels, that is, a problem that the uniformity of the visual field angle is not satisfactory occurs due to the alignment accuracy in the adhesive attachment work, the thickness accuracy of an adhesive layer, etc.

Furthermore, there is also considered a method for directly forming a transparent layer of 20 to 100 μm in thickness on barrier layers of a substrate on which the parallax barrier layers are formed in advance. However, this method has a handling problem when a thin transparent film or a glass substrate is handled, and also a problem that it is not easy to control the thickness of the transparent layer with an accuracy of 20 to 100±5 μm because the liquid crystal layer is sandwiched between the substrates, and thus no method has been put into practical use at present.

The present invention has been carried out in view of this point, and has an object to provide a display device and a manufacturing method thereof with which the uniformity of a visual field angle and the yield can be enhanced. Furthermore, the present invention has an object to provide a display device and a manufacturing method thereof with which the positional displacement between each parallax barrier and each pixel is suppressed.

### SUMMARY OF THE INVENTION

A display device according to the present invention is composed of: a display device main body including an array substrate, a counter substrate disposed so as to oppose the array substrate and an optically modulating layer interposed between the array substrate and the counter substrate, a plurality of pixels being formed and different images being enabled to be respectively displayed by a plurality of pixel groups each of which is constructed by a plurality of alternately-located pixels out of the a plurality of pixels; and parallax barrier layers that are provided on a surface of the counter substrate which is located at the opposite side to the optically modulating layer of the counter substrate, and separates the respective images displayed by the respective pixel groups from one another to display the respective separated images.

The parallax barrier layers for separating and displaying the images displayed by the respective pixel groups of the display device main body by using parallax at the opposite side to the optically modulating layer of the counter substrate.

Furthermore, a method for manufacturing a display device is composed of a display device main body including an array substrate, a counter substrate disposed so as to oppose the array substrate and an optically modulating layer interposed between the array substrate and the counter substrate, a plurality of pixels being formed and different images being enabled to be respectively displayed by a plurality of pixel groups each of which is constructed by a plurality of alternately-located pixels out of the plurality of pixels; and parallax barrier layers that separate and display the respective images displayed by the respective pixel groups of the display device main body by parallax, composed of: forming the parallax barrier layers on one principal surface of a first transparent substrate; adhesively attaching the one principal surface side of the first transparent substrate to a second transparent substrate; polishing the other principal surface side of the first transparent substrate to set the thickness of the first transparent substrate to a predetermined thickness; and forming a functional film on the other principal surface of the polished first transparent substrate, thereby forming the counter substrate.

The one-principal surface of the first transparent substrate on which the parallax barrier layers are formed is adhesively attached to the second transparent substrate, the other principal surface side of the first transparent substrate is polished to set the thickness of the first transparent substrate to a predetermined thickness, and the functional film is formed on the polished other principal surface of the first transparent substrate to thereby form the counter substrate.

As a result, the positional displacement between the parallax barrier layer and the pixel is suppressed, and the uniformity of the visual field angle and the yield can be enhanced.

Furthermore, a display device having a plurality of pixels, different images being enabled to be displayed by a plurality of pixel groups each of which is constructed by a plurality of alternately-located pixels out of the pixels, is equipped with a pair of substrates and an optically modulating layer interposed between the pair of substrates, wherein any one of the pair of substrates has one transparent substrate, a filter layer which is provided to the one transparent substrate and in which parallax barriers for separating and displaying images displayed by the respective pixel groups by parallax and color portions are successively arranged in juxtaposition with one another, and another transparent substrate adhesively attached to the one transparent substrate through the filter layer.

The filter layer having the parallax barriers and the color portions which are successively arranged in juxtaposition with one another is provided to the one transparent substrate, and the one transparent substrate is adhesively attached to the other transparent substrate through the filter layer, whereby the positional displacement between each parallax barrier and each pixel can be suppressed.

### BRIEF DESCRIPTION OF THE DRAWINGS

FIG. 1 is a cross-sectional view showing a display device according to a first embodiment of the present invention,

FIG. 2 is an enlarged view showing the operation of the display device,

FIG. 3 is a cross-sectional view showing a first step of a method for manufacturing the display device,

FIG. 4 is a cross-sectional view showing a second step of the method for manufacturing the display device,

FIG. 5 is a cross-sectional view showing a third step of the method for manufacturing the display device,

FIG. 6 is a cross-sectional view showing a fourth step of the method for manufacturing the display device,

FIG. 7 is a cross-sectional view showing a display device according to a second embodiment of the present invention,

FIG. 8 is an enlarged view showing the operation of the display device,

FIG. 9 is a cross-sectional view showing a first step of a method for manufacturing the display device,

FIG. 10 is a cross-sectional view showing a second step of the method for manufacturing the display device,

FIG. 11 is a cross-sectional view showing a third step of the method for manufacturing the display device,

FIG. 12 is a cross-sectional view showing a fourth step of the method for manufacturing the display device,

FIG. 13 is a cross-sectional view showing a fifth step of the method for manufacturing the display device,

FIG. 14 is a cross-sectional view showing a sixth step of the method for manufacturing the display device,

FIG. 15 is a cross-sectional view showing a display device according to a third embodiment of the present invention,

FIG. 16 is a cross-sectional view showing a first step of a method for manufacturing the display device,

FIG. 17 is a cross-sectional view showing a second step of the method for manufacturing the display device,

FIG. 18 is a cross-sectional view showing a third step of the method for manufacturing the display device,

FIG. 19 is a cross-sectional view showing a fourth step of the method for manufacturing the display device,

FIG. 20 is a cross-sectional view showing a fifth step of the method for manufacturing the display device, and

FIG. 21 is a cross-sectional view showing a sixth step of the method for manufacturing the display device.

### DETAILED DESCRIPTION OF THE PREFERRED EMBODIMENTS

The construction of a display device according to a first embodiment of the present invention will be described hereunder with reference to the accompanying drawings.

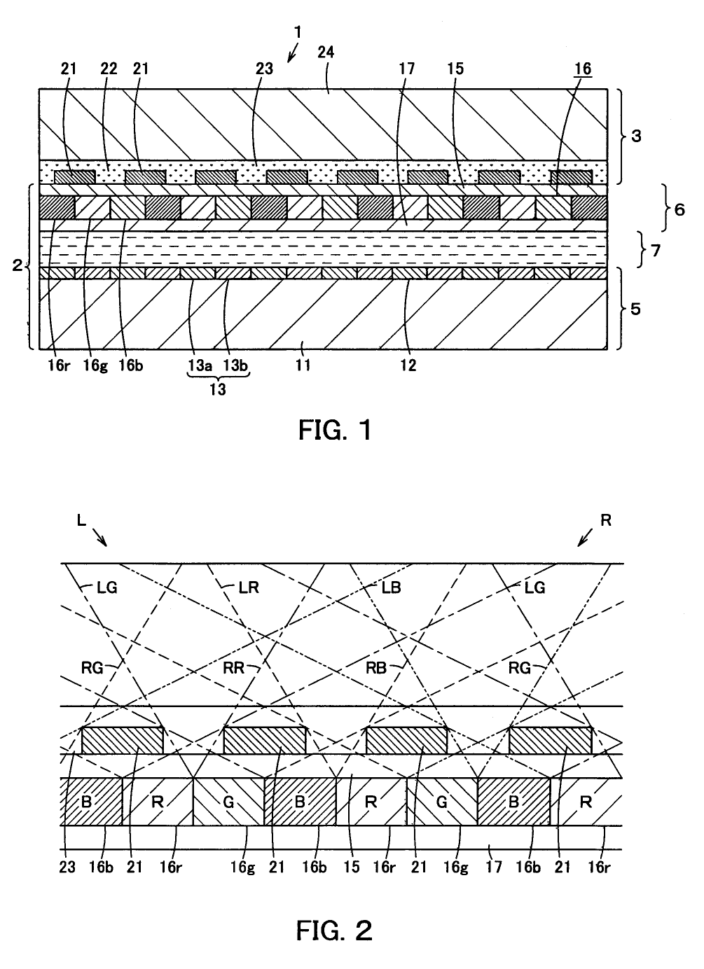

In FIG. 1, 1 represents a liquid crystal cell which is a liquid crystal display device as a display device, and this liquid crystal cell 1 is used for a multiple view directional display as a display device which can display different images in different directions when the liquid crystal cell 1 is illuminated with light from the back side thereof by a backlight as a planar light source device (not shown) and it is observed from different directions.

The liquid crystal cell 1 is equipped with a display device 2 as a display device main body for displaying a plurality of images at the same time, and an optical device 3 as an optical device for separating images so that images displayed on the display device 2 can be individually visualized from predetermined different viewing-angle directions.

In the display device 2 a general active matrix type TFT liquid crystal display device having an RGB stripe structure is generally used. That is, the display device 2 has the structure that a liquid crystal layer 7 as an optically modulating layer is interposed between an array substrate 5 and a counter substrate 6 which are held from each other at a fixed interval by spacers (not shown).

In the array substrate 5, TFTs as switching elements (not shown), and pixel electrodes 12, etc., are formed on a transparent substrate 11, and a plurality of pixels 13 are formed in a matrix form. In the counter substrate 6, striped color filter layers 16 (color filter layers 16r, 16g, 16b) of respective colors of RGB, and an ITO electrode 17 of a transparent electrode as a counter electrode, etc., are laminated on a principal surface at the liquid crystal layer side 7 of a transparent first transparent electrode 15. The array substrate 5 and the counter substrate 6 are attached to each other to thereby construct a pixel unit as a pixel portion having the plurality of pixels 13.

The display device 2 is enabled to display a predetermined image and further display a plurality of different images by a driving circuit (not shown). That is, two pixel groups are constructed by a plurality of pixels 13a and a plurality of pixels 13b of the plurality of pixels 13 which are alternately arranged line by line in such a direction as a right-and-left direction or the like along which images are separated by parallax, and an individual image can be displayed by each of the two pixel groups.

It is preferable that a first transparent substrate 15 as an intermediate layer is normally set to 20 to 100 μm in thickness although it is dependent on the pixel size of the liquid crystal cell 1. Furthermore, in consideration of the use efficiency of light, a material having high transmittance such as glass, acryl or the like is preferably used for the first transparent substrate 15 and also a material having high heat resistance of about 100 to 200° C. is preferable to provide a color filter layer 16 for color display.

On the other hand, in the optical device 3, parallax barrier layers 21 serving as light shielding portions and slit portions 22 serving as transparent portions are alternately formed along an image separating direction by parallax on the principal surface of the first transparent substrate 15 at the opposite side to the liquid crystal layer 7, and these parallax barrier layers 21 are covered by a transparent adhesive layer 23 and a second transparent substrate 24. The parallax barrier layers 21 and the slit portions 22 constitute an image separating portion 25.

The parallax barrier layers 21 are formed of black resin resist material having little light reflection, or the surfaces of the parallax barrier layers 21 are subjected to a light antireflection treatment. Furthermore, the parallax barrier layers 21 are formed between respective two adjacent pixels 13 in the image separating direction by parallax of the display device 2 and at the pitch corresponding to every two pixels 13.

The slit portions 22 are made transparent by the adhesive layer 23.

The second transparent substrate 24 is a transparent layer for protecting the parallax barrier layers 21, and serves as the counter substrate of the liquid crystal cell.

The optical device 3 is disposed at the front side of the display device 2, and the parallax barrier layers 21 are continuously formed in the display device 2. Each of the back side of the display device 2 and front side of the optional device 3 is provided with a polarizing layer (not shown).

The backlight is equipped with a light source (not shown) and a light guide plate to which light of the light source is incident and which emits the light from the surface opposing the back side of the liquid crystal cell 1.

As shown in FIGS. 1 and 2, in the liquid crystal cell 1, different images are respectively displayed by the pixel group of the plurality of pixels 13a and the pixel group of the plurality of pixels 13b, the pixels 13a and the pixels 13b being alternately arranged line by line in the image separating direction by parallax (in the right-and-left direction). Accordingly, when the liquid crystal cell 1 is viewed from a predetermined visual-angle direction L, the image displayed by the pixel group of the plurality of pixels 13a is shielded by the parallax barrier layers 21, and the image displayed by the pixel group of the plurality of pixels 13b is visualized through the slit portions 22. On the other hand, when the liquid crystal cell 1 is viewed from a predetermined visual angle direction R, the image displayed by the pixel group of the plurality of pixels 13b is shielded by the parallax barrier layers 21, and the image displayed by the pixel group of the plurality of pixels 13a is visualized through the slit portions 22. At this time, in each visual angle direction L, R, light LR, LG, LB and light RR, RG, RB passing through the color filter layers 16r, 16g and 16b are visualized through each slit portion 22, so that the images of these colors are combined with one another, and visualized as a color image.

Next, a method for manufacturing the display device according to the first embodiment will be described.

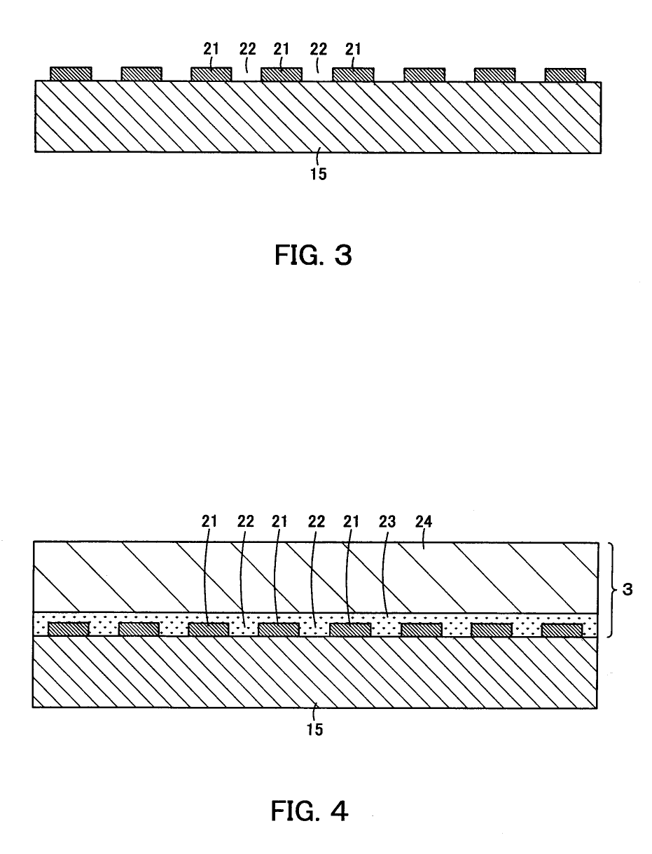

First, as shown in FIG. 3, in the manufacturing process of the counter substrate 6, the parallax barrier layers 21 are formed on the first transplant substrate 15 of 0.5 to 0.7 mm in thickness such as a glass substrate or the like used in a conventional manufacturing line by using metal film, black resist material or the like (first step).

Subsequently, as shown in FIG. 4, the second transparent substrate 24 serving as a protection layer for the parallax barrier layers 21 is adhesively attached via the adhesive layer 23 onto the first transparent substrate 15 having the parallax barrier layers 21 formed thereon (second step).

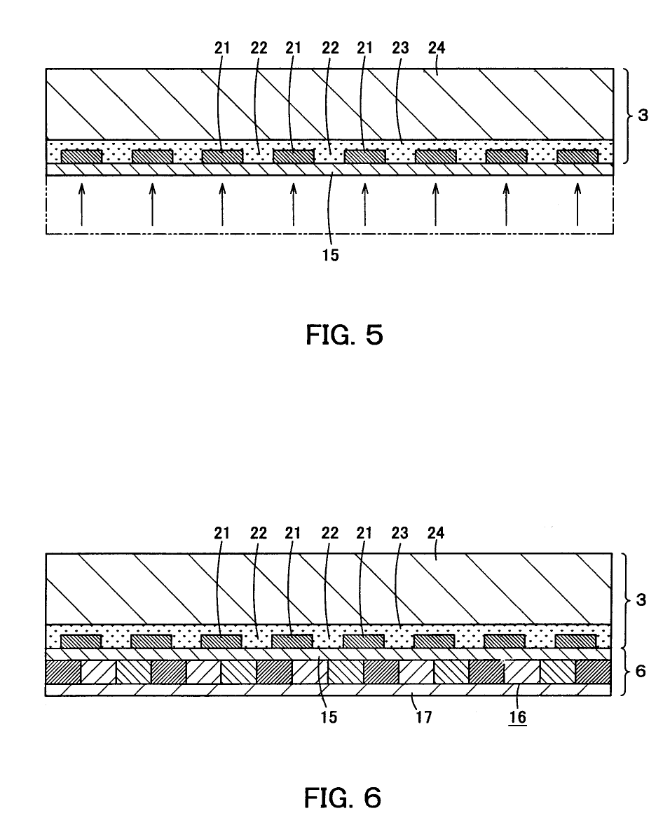

Furthermore, after the transparent substrates 15 and 24 are adhesively attached to each other, as shown in FIG. 5, the opposite side to the parallax barrier layer 21 side of the first transparent substrate 15 on which the parallax barrier layers 21 are formed is polished to set the thickness of the first transparent substrate 15 at 20 to 100 μm in thickness, thereby forming the counter substrate 6 having the parallax barrier layers 21 (third step).

Then, functional films constituting matrix type display elements constituting the pixels 13 such as a black matrix, the color filter layer 16, the ITO electrode 17, etc., are suitably formed as shown in FIG. 6 on the opposite surface of the polished counter substrate 6 to the surface on which the parallax barrier layers 21 are directly formed by using the parallax barrier layers 21 as a benchmark as occasion demands (fourth step).

Thereafter, the counter substrate 6 is adhesively attached to the formed in advance array substrate 5 via a predetermined spacer by a seal member (not shown) or the like, and then the liquid crystal layer 7 is injected into the gap between the substrates 5, 6, thereby completing the liquid crystal cell 1 (fifth step).

As described above, in the first embodiment, the parallax barrier layers 21 are provided onto the first transparent substrate 15, and the second transparent substrate 24 is adhesively attached to the parallax barrier layer 21 side. In addition, the opposite side to the parallax barrier layer 21 side of the first transparent substrate 15 is polished, and various kinds of function films are formed on the polished first transparent substrate 15, thereby forming the counter substrate 6.

That is, in the conventional case where the parallax barrier layers are formed on the second transparent substrate and the functional film is formed in advance and adhesively attached to the first transparent substrate to which the array substrate is adhesively attached, the positioning between each pixel 13 and each parallax barrier layer was not easy. However, according to this embodiment, the second transparent substrate 24 is adhesively attached to the opposite side to the pixels 13 which have a decisive influence on the visual field angle in the multiple view direction, and thus it is hardly required to control the thickness of the adhesive layer 23. Accordingly, variation in the visual field angle which has been problem in the manufacturing process of the conventional multiple view directional display and is caused by the positional displacement between the parallax barrier layer and the color filter or the black matrix layer in the adhesive attachment step can be improved, and the yield in the adhesive attachment step which has lowered the yield in the manufacturing process of the conventional liquid crystal cell 1 can be enhanced.

Furthermore, the first transparent substrate 15 which is fixed to the second transparent substrate 24 by the adhesive layer 23 is polished, and thus there hardly occurs unevenness in polishing which has been problematic in the polishing step of the conventional liquid crystal cell and is caused by the difference in polishing pressure between the center portion and peripheral portion of the cell, so that the yield in the polishing process can be enhanced.

Still furthermore, the first transparent substrate 15 having the parallax barrier layers 21 formed thereon is polished. Therefore, as compared with the case where the completed liquid crystal cell 1 is polished, even if defectives occur, the loss can be greatly reduced.

By using the counter substrate 6 having the parallax barrier layers 21 formed in the above process, the multiple view directional display having excellent uniformity in visual field angle can be easily supplied by the same manufacturing process as the conventional liquid crystal cell process.

Furthermore, the parallax barrier layers 21 can be physically and chemically protected by providing the second transparent substrate 24 as a transparent layer covering the parallax barrier layers 21.

The same operation and effect can be achieved if no color filter layer 16 is provided to achieve a monochromatic image in the first embodiment.

Next, the construction of a second embodiment according to the present invention will be described with reference to the accompanying drawings.

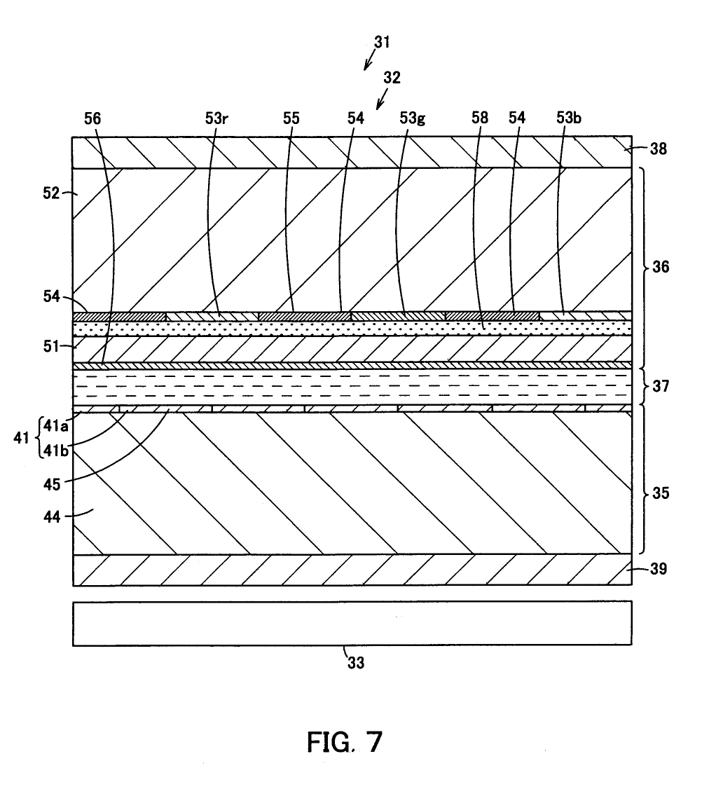

In FIG. 7, 31 represents a multiple view display which is a liquid crystal display device as a display device, and the multiple view display 31 has a display device 32 which is a liquid crystal display device (display device main body) as a display device, and a backlight 33 for illuminating from the back side of the display device 32.

The display device 32 displays a plurality of images at the same time, and it is an active matrix type TFT device, for example. An array substrate 35 as a substrate and a counter substrate 36 as a substrate are arranged so as to oppose each other at a predetermined interval via a spacer (not shown), a liquid crystal layer 37 as an optically modulating layer is interposed between the substrates 35 and 36, and two polarizing plates 38, 39 at the backlight 33 side (light source side) and the observer side are provided. Furthermore, in the display device 32, the array substrate 35 and the counter substrate 36 are attached to each other to thereby construct a pixel unit as a pixel portion having a plurality of pixels 41. Furthermore, the display device 32 is designed so that an interlaced image can be displayed by a driving circuit (not shown), for example, and furthermore it can display a plurality of different images.

In the array substrate 35, wires such as scanning lines and signal lines (not shown) are provided in a grid form on a substrate 44 having translucency such as a glass substrate or the like, and TFTs as switching elements are arranged in a matrix form in proximity to the cross portions of these wires. A pixel electrode 45 as a transparent electrode formed of ITO or the like is provided on the TFTs, etc., of the array substrate 35.

On the other hand, the counter substrate 36 is also called a counter CF (color filter) substrate, and it has a first substrate 51 and a second substrate 52 as transparent substrates having translucency such as glass substrates or the like, and color filters 53r, 53g, 53b of three colors of RGB as colored portions and a filter layer 55 having a plurality of parallax barriers 54 formed in a direction along which images are separated by parallax, for example, in a right-and-left direction provided between the substrates 51 and 52. A counter electrode 56 which is a transparent electrode as a functional film formed of ITO or the like is provided to the opposite side of the filter layer 55 of the first substrate 51.

The functional film is not limited to the counter electrode 56, but it may contain any film for constituting the pixels 41 such as a black matrix or the like, for example.

The parallax barriers 54 are formed of a light non-transmissible metal such as chrome or resin dispersed with black pigment such as carbon black or the like. These are also formed in the process of manufacturing the color filters 53r, 53g, 53b, and arranged among the color filters 53r, 53g, 53b. That is, the parallax barriers 54 are disposed between the color filters 53r and 53g, between the color filters 53g and 53b and between the color filters 53b and 53r.

Furthermore, the filter layer 55 is formed on a principal surface of the second substrate 52 as a transparent substrate at the opposite side to the liquid crystal layer 37, the principal surface concerned opposing the first substrate 51, and the filter layer 55 is also covered by the adhesive layer 58 by which the first substrate 51 and the second substrate 52 are adhesively attached to each other.

Here, the adhesive layer 58 is a transparent layer formed of UV-curable resin or the like, and a material preferably having no contractility and the same level refractive index as glass.

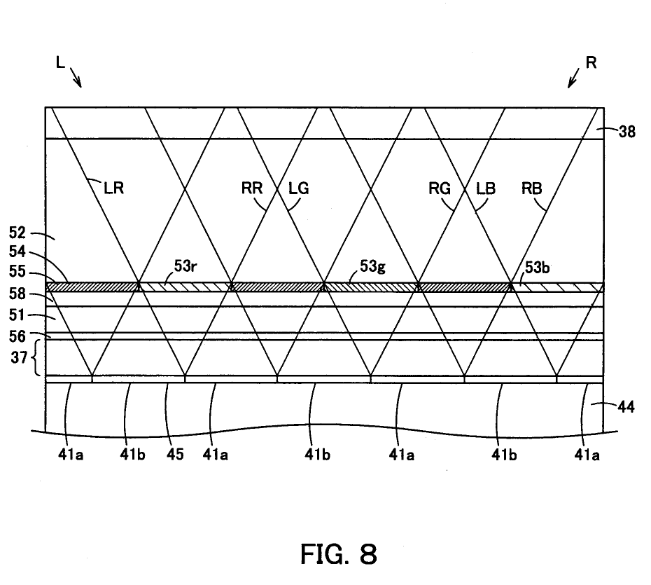

In the display device 32 described above, as shown in FIGS. 7 and 8, the plurality of pixels 41a and the plurality of pixels 41b of the plurality of pixels 41 are alternately arranged line by line in a direction (in the right-and-left direction in FIGS. 7 and 8) along which images are separated from each other by parallax, and different images are respectively displayed by the pixel group of the plurality of pixels 41a and the pixel group of the plurality of pixels 41b, respectively. Therefore, when the display device 32 is viewed from a predetermined visual angle direction L, the image displayed by the pixel group of the plurality of pixels 41b is shielded by the parallax barriers 54, and the image displayed by the pixel group of the plurality of pixels 41a is visualized through the respective color filters 53r, 53g, 53b. On the other hand, when the display device 32 is viewed from a predetermined visual angle direction R, the image displayed by the pixel group of the plurality of pixels 41a is shielded by the parallax barriers 54, and the image displayed by the pixel group of the plurality of pixels 41b is visualized through the respective color filters 53r, 53g, 53b. At this time, in each of the visual angle directions L and R, light LR, LG, LB and light RR, RG, RB passing through the color filters 53r, 53g, 53b of the respective colors of RGB are visualized, whereby these color images are combined with one another and thus visualized as a color image.

Next, the method for manufacturing the display device according to the second embodiment will be described.

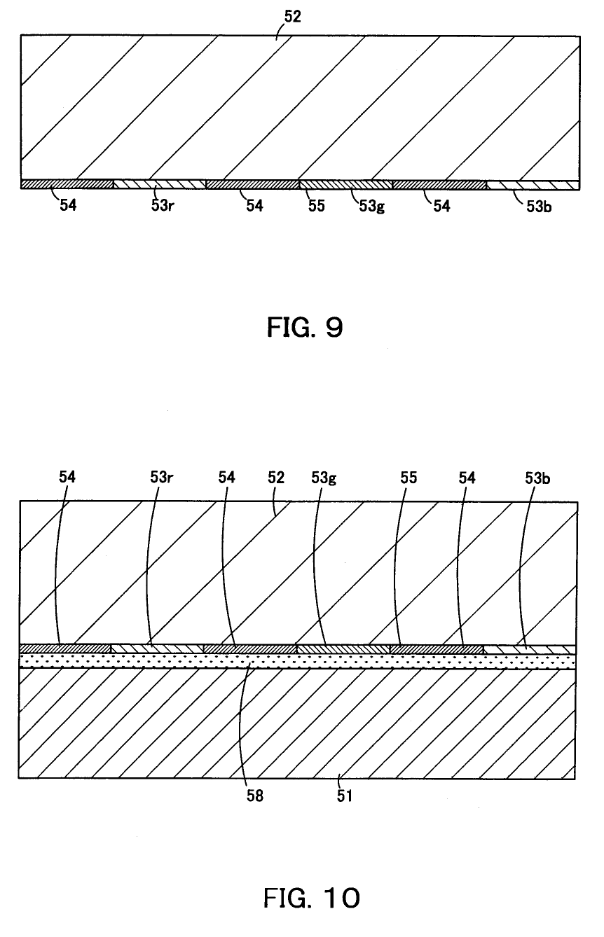

First, as shown in FIG. 9, the color filters 53r, 53g, 53b and the parallax barriers 54 are formed on the second substrate 52 (first step). For example, when the pitch of the pixels 41 of the array substrate 35 is equal to 63.5 μm, the width of the color filters 53r, 53g, 53b is set to 40 μm, the width of the parallax barriers 54 is set to 87 μm, and the parallax barriers 54 are formed among the respective RGB color filters 53r, 53g, 53b.

Thereafter, as shown in FIG. 10, the adhesive layer 58 of UV-curable resin or the like is applied at a thickness of 35 μm, and the substrates 51 and 52 are adhesively attached to each other (second step).

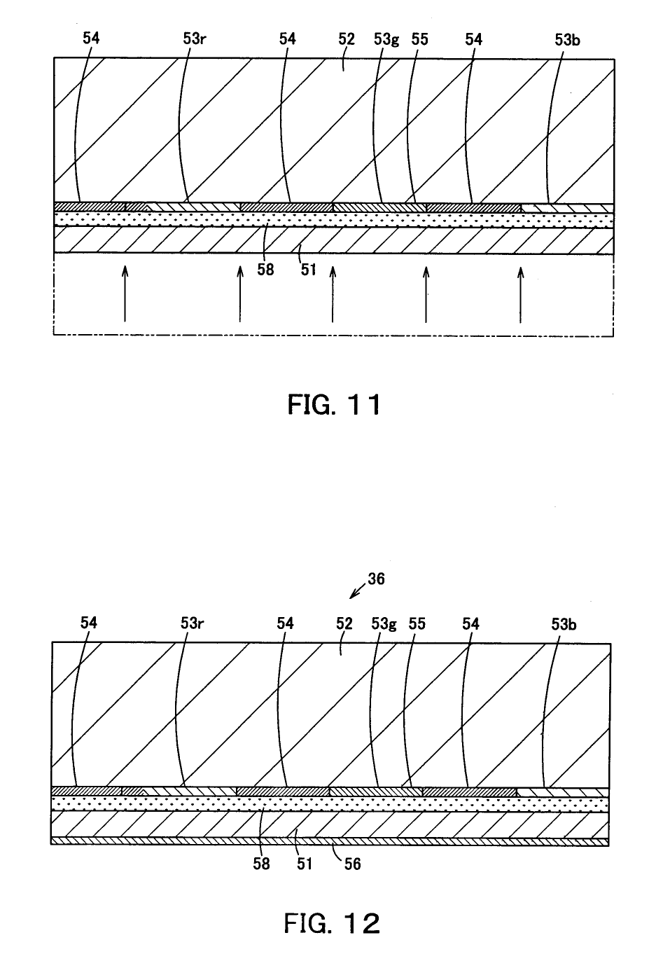

Furthermore, as shown in FIG. 11, mechanical polishing or chemical polishing is conducted until the thickness of the first substrate 51 is equal to a predetermined thickness, for example, 55 μm in this case (third step).

As shown in FIG. 12, the counter electrode 56 such as an ITO electrode or the like is formed on a principal surface of the polished first substrate 51, the principal surface concerned opposing the liquid crystal layer 37, that is, the principal surface at the opposite side to the second substrate 52, thereby achieving the counter substrate 36 (fourth step).

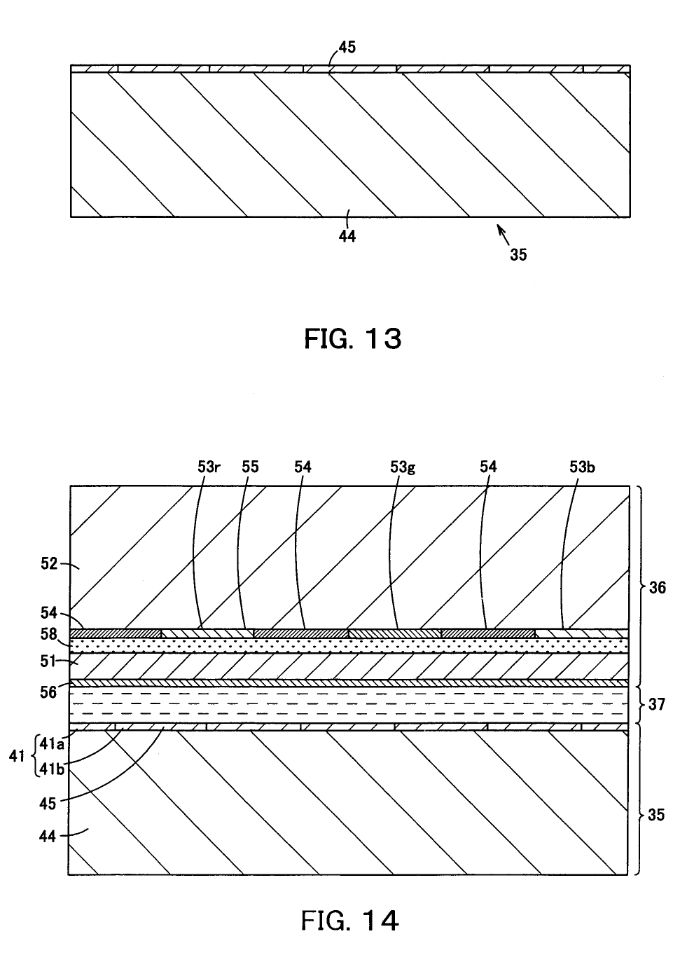

Subsequently, as shown in FIG. 13, the pixel electrodes 45, TFTs, etc., are formed in a matrix form on the substrate 44 so as to achieve a desired pixel pitch, thereby achieving the array substrate 35 (fifth step).

Then, as shown in FIG. 14, the array substrate 35 and the counter substrate 36 are adhesively attached to each other via a spacer or the like so that the center lines of the parallax barriers 54 and the color filters 53r, 53g, 53b are made coincident with the boundaries of the adjacent pixel electrodes, and liquid crystal material is injected to form the liquid crystal layer 37, thereby achieving the display device 32 (sixth step).

Finally, as shown in FIG. 7, the polarizing plates 38 and 39 and the backlight 33 are combined with the display device 32, thereby forming the multiple view display 31 (seventh step).

As described above, according to the second embodiment, the filter layer 55 having the parallax barriers 54 and the color filters 53r, 53g, 53b which are successively juxtaposed with one another is provided to the second substrate 52, and the second substrate 52 is adhesively attached to the first substrate 51 through the filter layer 55. Accordingly, as compared with the conventional case where the second substrate having the parallax barriers formed thereon is adhesively attached to the first substrate 51 having the color filters formed thereon by the adhesive layer or the like, work for positioning the color filters 53r, 53g, 53b and the parallax barriers 54 is unnecessary, and thus the positional displacement between each parallax barrier 54 and each pixel 41 can be suppressed.

Since the positional displacement between the parallax barrier 54 and the pixel 41 can be suppressed, the uniformity of the visual field angle of the display device 32 can be enhanced, occurrence of defectives caused by the positional displacement between the parallax barrier 54 and the pixel 41 can be suppressed, and the yield can be enhanced.

Furthermore, in the conventional manufacturing method, the counter substrate is polished until the thickness thereof is equal to a predetermined thickness after the liquid crystal layer is formed, and there are many factors that lower the yield, for example, the counter substrate may be cracked or peeled off by polishing pressure, pad portions may be corroded making it impossible to display an image, etc., However, according to this embodiment, only the substrates 51, 52 between which the color filters 53r, 53g, 53b and the parallax barriers 54 are provided are subjected to the polishing step, and after the polishing step, the liquid crystal material is injected to form the liquid crystal layer 37, that is, the step of forming the liquid crystal layer 37 is set to the last step. Accordingly, there hardly occurs unevenness in polishing which would occur due to the difference in polishing pressure between the center portion and the peripheral portion of the display device 32, and damage of the display device 32 can be suppressed, whereby factors affecting the final yield can be reduced. In addition, a countermeasure can be easily taken for the positional displacement between the parallax barrier 54 and the pixel 41 by the existing cell forming process, and can thus the yield be suppressed.

Furthermore, since the first substrate 51 is polished before the liquid crystal layer 37 is formed, the loss undergone when defectives occur can be more greatly reduced as compared with the case where the completed display device 32 is polished.

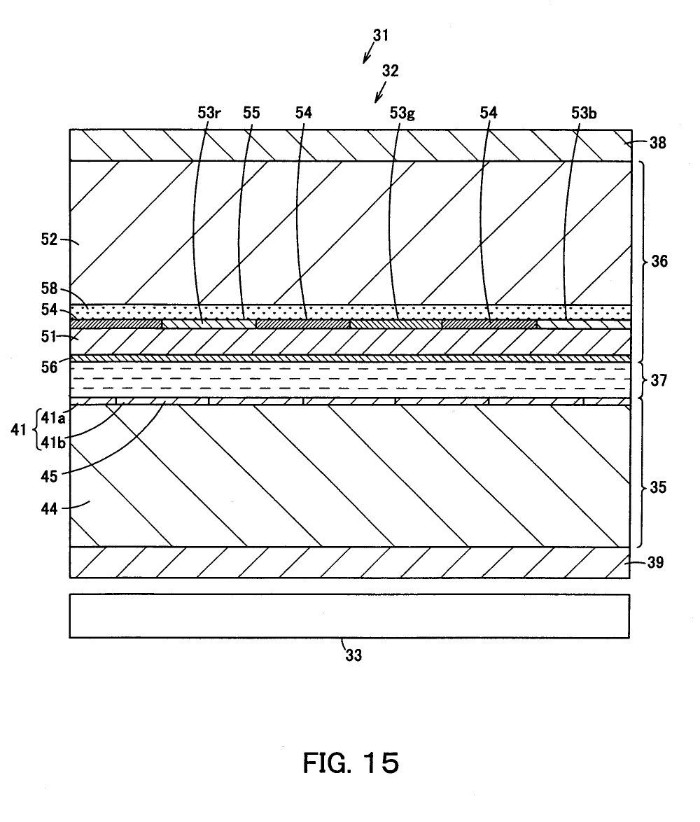

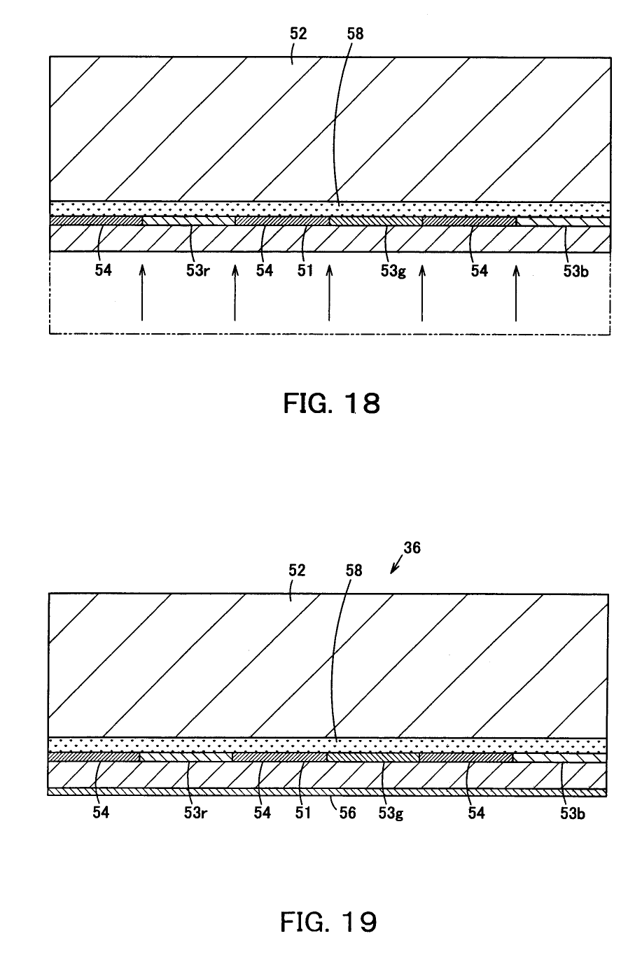

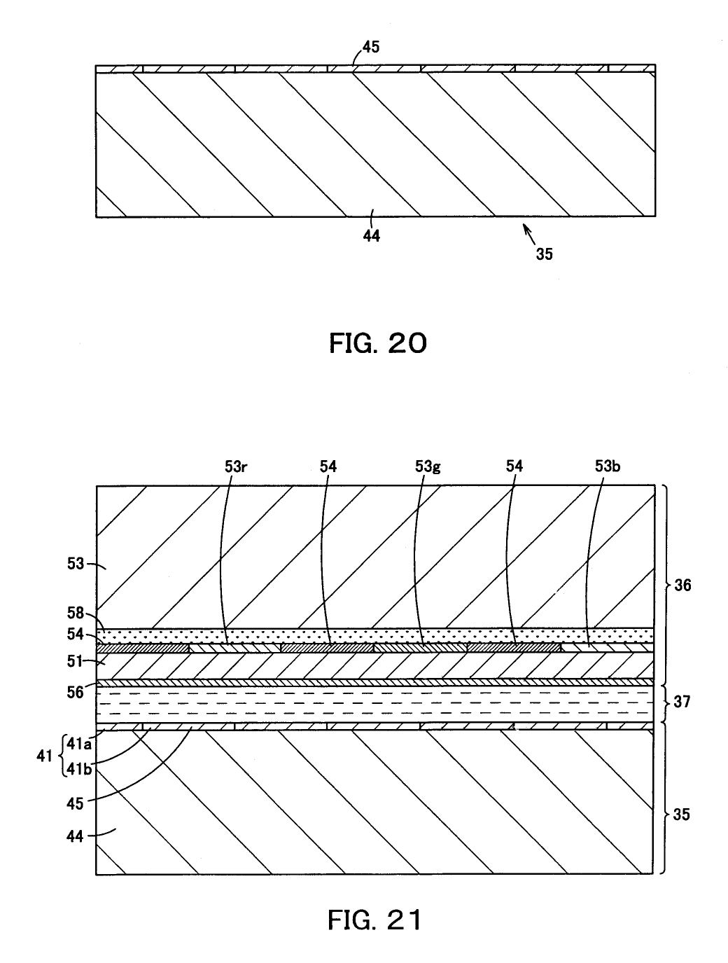

Next, a third embodiment will be described with reference to FIGS. 15 to 21. The same construction and operation as the second embodiment are represented by the same reference numerals and the descriptions thereof are omitted.

In the third embodiment, the filter layer 55 of the display device 32 is formed on a principal surface of the first substrate 51 as the transparent substrate which opposes the liquid crystal layer 37, the principal surface concerned opposing the second substrate 52.

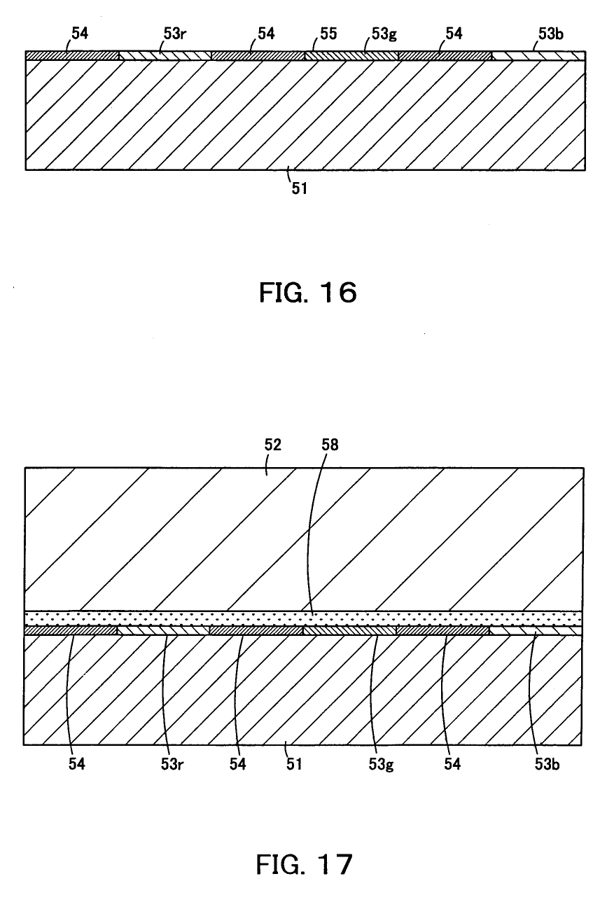

According to the method for manufacturing the display device 32, as shown in FIG. 16, the color filters 53r, 53g, 53b and the parallax barriers 54 are formed on the first substrate 51 (first step). At this time, the widths of the color filters 53r, 53g, 53b and the parallax barriers 54 are set the same as the first step of the above second embodiment.

Thereafter, as shown in FIGS. 17 to 21, the multiple view display 31 is achieved by the same second to seventh steps as the second embodiment.

In the third embodiment, the first substrate 51 provided with the filter layer 55 is adhesively attached to the second substrate 52 through the filter layer 55, whereby the same operation and effect as the second embodiment can be achieved.

Furthermore, in the second and third embodiments, the substrate having the filter layer 55 formed thereof is set to the counter substrate 36. However, the filter layer 55 may be formed at the array substrate 35 side. In this case, the array substrate 35 is formed of a pair of transparent substrates, and scanning lines, signal lines, TFTs, pixel electrodes, etc., are provided as functional films, for example, whereby the same operation and effect as each embodiment can be achieved.

Still furthermore, in each embodiment described above, the display device is not limited to the active matrix type TFT liquid crystal display device, and any other display devices may be used.

What is claimed is:

1. A display device according to the present invention comprising:
a display device main body including an array substrate, a counter substrate disposed so as to oppose the array substrate and an optically modulating layer interposed between the array substrate and the counter substrate, a plurality of pixels being formed and different images being enabled to be respectively displayed by a plurality of pixel groups each of which is constructed by a plurality of alternately-located pixels out of the plurality of pixels; and
parallax barrier layers that are provided on a surface of the counter substrate which is located at the opposite side to the optically modulating layer, and separates the respective images displayed by the respective pixel groups from one another to display the respective separated images.

2. The display device according to claim 1, further comprising a transparent layer covering the parallax barrier layers.

3. The display device according to claim 1 or 2, wherein the counter substrate has a colored portion corresponding to each pixel.

4. A display device having a plurality of pixels in which different images can be displayed by a plurality of pixel groups each comprising the plurality of pixels, the respective plurality of pixels of the plurality of pixel groups being alternately arranged, comprising:
a pair of substrates; and
an optically modulating layer interposed between the pair of substrates, wherein any one of the pair of substrates is equipped with one transparent substrate, a filter layer that is provided to the one transparent substrate and includes parallax barriers and colored portions which are successively juxtaposed with one another to separate and display the images displayed by the respective pixel groups by parallax, and another transparent substrate adhesively attached to the one transparent substrate through the filter layer.

5. The display device according to claim 4, wherein the other transparent substrate is located so as to oppose the optically modulating layer.

6. The display device according to claim 4, wherein the other transparent substrate is located at the opposite side to the optically modulating layer.

7. The display device according to claim 1 or 4, wherein the optically modulating layer is a liquid crystal layer.

8. A method for manufacturing a display device including a display device main body including an array substrate, a counter substrate disposed so as to oppose the array substrate and an optically modulating layer interposed between the array substrate and the counter substrate, a plurality of pixels being formed and different images being enabled to be respectively displayed by a plurality of pixel groups each of which is constructed by a plurality of alternately-located pixels out of the plurality of pixels; and parallax barrier layers that separate and display the respective images displayed by the respective pixel groups by parallax, comprising:
forming the parallax barrier layers on one principal surface of a first transparent substrate;
adhesively attaching the one principal surface side of the first transparent substrate to a second transparent substrate;
polishing the other principal surface side of the first transparent substrate to set the thickness of the first transparent substrate to a predetermined thickness; and
forming a functional film on the other principal surface of the polished first transparent substrate, thereby forming the counter substrate.

9. A method for manufacturing a display device having a pair of substrates and an optically modulating layer interposed between the pair of substrates in which a plurality of pixels are formed and different images can be displayed by a plurality of pixel groups each comprising the plurality of pixels, the respective plurality of pixels of the plurality of pixel groups being alternately arranged, comprising:
forming on the one transparent substrate a filter layer including parallax barriers and colored portions that are successively juxtaposed with one another to separate and display the images displayed by the respective pixel groups by parallax; and
adhesively attaching the one transparent substrate having the filter layer formed thereon to another transparent substrate through the filter layer.

10. The method for manufacturing the display device according to claim 9, further comprising:
polishing the other transparent substrate adhesively attached to the one transparent substrate until the thickness of the other transparent substrate is equal to a predetermined thickness;
forming a predetermined functional resin on the polished other transparent substrate to set the other transparent substrate as any one of the pair of substrates; and
forming the optically modulating layer between the one substrate and the other substrate of the pair of substrates.

11. The method for manufacturing the display device according to claim 9, wherein the other transparent substrate is located so as to oppose the optically modulating layer.

12. The method for manufacturing the display device according to claim 9, wherein the other transparent substrate is located at the opposite side to the optically modulating layer.

13. The method for manufacturing the display device according to claim 8 or 9, wherein the optically modulating layer is a liquid crystal layer.
